(19) United States
(12) Patent Application Publication
(10) Pub. No.: US 2007/0146480 A1
(43) Pub. Date: Jun. 28, 2007

(54) Apparatus and method for inspecting areas surrounding nuclear boiling water reactor core and annulus regions

(76) Inventors: John Joseph Judge JR., Vernon, VT (US); Michael Jamie Baron, New Lenox, IL (US)

Correspondence Address: JENNER & BLOCK, LLP, ONE IBM PLAZA, CHICAGO, IL, 60611, US

(21) Appl. No.: 11/316,445

(22) Filed: Dec. 22, 2005

(51) Int. Cl. H04N 7/18

(52) U.S. Cl. 348/83

(57) ABSTRACT

A remotely controlled apparatus (112) for inspecting the core (102) and annulus (104) areas of nuclear boiling water reactors (100) includes a circumferential drive mechanism for propelling the apparatus (112) on the steam dam (108) of the reactor (100). The inspection apparatus (112) uses a set of driver rollers (314) that grip the side of the steam dam (108) and provide propulsion for the apparatus. A pinch-roller assembly with high-tension springs (308) and pneumatic air cylinders (310) is utilized for removably securing a set of pinch rollers (312) to the side of the steam dam opposite the side of the driver rollers (314). A set of rollers (304) are adapted to rest on top of the steam dam (108), supporting the weight of the apparatus (112) and enabling the apparatus to move around the steam dam (108). Two positioning guide rails (306) aid in the balance of the apparatus (112), especially when it is stationary. The apparatus (112) has a watertight main body (202), which houses the electrical control wiring and circuitry. The main body (202) has a front camera (204) and a rear camera (205) used to direct the movements of the apparatus (112). The main body also has two turret-type telescoping mast assemblies (208) with telescoping masts 210 and 212, which are capable of extending at a selected distance above and below the main body (202). The mast assemblies 210 and 212 support inspection equipment such as radiation-shielded EVT-1-capable video cameras and radiation-tolerant fiberscopes. The apparatus (112) and its inspection tools are remotely controlled via control consoles with video monitors from a low-dose, non-contaminated enclosure located remotely from a boiling water reactor.

### FIELD OF THE INVENTION

The present invention relates generally to an inspection tool and maintenance method for a nuclear power plant, and in particular, to a remotely operable inspection tool and method of using the same for inspecting boiling water reactor in-vessel, annulus and surrounding areas.

### BACKGROUND OF THE INVENTION

Boiling water reactors (“BWRs”) typically utilize a jet pump system as a means of regulating reactor flow. In a common arrangement, twenty individual jet pumps, in two “loops” of ten each, are located in the annulus area just inside the reactor vessel invert. The annulus, the jet pumps and the core shroud are subject to scheduled and augmented inspections that may result in required maintenance or retrofit activities.

Because water is used as a radiation shield in BWRs, much of the inspection activity occurs under water (see, e.g., U.S. Pat. No. 5,254,835 to Dalke et al., FIG. 1) (“the '835 patent”). Normally, Reactor Service Technicians (“RSTs”) work above the water in the reactor cavity on fuel bridges ( e.g., the '835 patent, FIG. 1) or specialized platforms, using hand-held or pole-mounted cameras (see, e.g., U.S. Pat. No. 5,305,356 to Brooks et al., FIG. 4) (“the '356 patent”) and other tools that dip into the reactor cavity for inspection (see, e.g., U.S. Pat. No. 6,219,399 B1 to Naruse et al.) (“the '399 patent”). RSTs directly manipulate this underwater equipment in order to carry out the inspection of the reactor cavity and jet pumps. Sometimes, this step is carried out by divesuit-wearing RSTs submerged under water (e.g., the '399 patent, FIGS. 3-4, 7-8). Unfortunatelly, the RSTs' exposure to radiation, as much as 20 milli-REM (mR) per hour, may be considerable and is undesirable. To avoid radiation exposure, remotely operated equipment is used in place of RSTs. This can provide dose savings on an ongoing per-outage basis of about two REM (R) or more, depending on work scope.

Specialized platforms are often used to support remotely operated maintenance and inspection equipment. This is undesirable because it adds costs and introduces additional equipment into the environment of a BWR.

In an outage, a window of time exists where equipment inspections may take place. Shortening maintenance and inspection time of BWRs leads to cost savings by decreasing reactor outage time. Exemplary conservative cost savings for 48 hours are as follows: at $22 per mega watt hour×900 mega watts=$19,800×48 hours=$950,400. In addition, $1,000,000 per day outage costs, consiting of man power costs, rental equipment costs, materials costs, and replacement power costs may be added to the total cost savings. Thus, for a two day outage, total cost savings would equal $2,950,400. On average, there is one such outage per 18 months per plant.

Various robotic devices for maintenance and inspection and methods for using these devices are known. However, these robotic devices and associated methods still require substantial undesired exposure for RSTs or need specialized platforms to function. For example, the '399 patent to Naruse describes a maintenance method in a nuclear power plant. The disclosed method utilizes human RSTs and does not prevent unnecessary radiation exposure to the RSTs. The '835 patent to Dalke describes a robotic welder for nuclear boiling water reactors. The robotic welder disclosed in the '835 patent is largely stationary and must be guided to the welding place of interest by RSTs. It is capable of only a few degrees of independent movement and is incapable of performing inspections. The inspection device of the '356 patent to Brooks is a pole-mounted camera that must be hand-carried by RSTs.

U.S. Pat. No. 4,638,234 to Schröder et al. (“the '234 patent”) describes an apparatus for performing remotely manipulated maintenance on parts of equipment in a shielded nuclear facility. Remote maintenance has the advantage of reduing exposure for RSTs. The apparatus described in the '234 patent, however, is incapable of operating in the confines and the environment of a BWR. The '234 apparatus is incapable of self-propulsion, requires specialized inspection platforms, and is used in large-area process cells of facilities for reprocessing irradiated nuclear fuels. Likewise, U.S. Pat. No. 5,350,033 to Kraft (“the '033 patent”) describes a robotic inspection vehicle. While the robotic vehicle of the '033 patent is remotely controllable, it requires the utilization of specialized platforms in order to be useful in the inspection of a BWR.

Similarly, other remotely and non-remotely operated mobile robots and devices or methods, some of which may be used in nuclear power plants in general, cannot be utilized in the inspection of a BWR without the use of specialized inspection platforms. These devices and methods are, for example, U.S. Pat. No. 4,736,826 to White et al., U.S. Pat. No. 6,588,701 B2 to Yavnai, U.S. Pat. No. 6,459,748 B1 to Everett et al., U.S. Pat. No. 6,446,718 B1 to Barret et al., U.S. Pat. No. 6,405,798 B1 to Barrett et al., U.S. Pat. No. 4,696,612 to Germond et al., U.S Pat. No. 4,919,194 to Gery et al., U.S Pat. No. 5,351,621 to Tanaka et al., U.S. Pat. No. 4,661,308 to Takenaka et al., U.S Pat. No. 5,174,405 to Carra et al., and U.S. Pat. No. 5,248,008 to Clar.

Therefore, a need in the art exists for an efficient apparatus and method for performing inspections of a BWR while preventing harmful radiation exposure to RSTs and eliminating the need for specialized inspection platforms.

### SUMMARY OF THE INVENTION

The needs are met and an advance in the art is made by the presently contemplated apparatus and method for remotely inspecting and maintaining the annulus and in-vesssel areas of a BWR.

In accordance with one aspect of the present invention, a remotely controlled, self-propelled apparatus for inspecting the annulus and in-vessel areas of boiling water reactors includes a drive mechanism for propelling the apparatus on the circumferential steam dam of the reactor. The apparatus uses a spring-loaded drive wheel assembly and positioning and stabilizing guide rails for attachment and locomotion on the reactor steam dam.

The apparatus has a watertight main body, which houses the electrical control circuitry and wiring. The main body is a vehicle, which attaches to, and navigates along, the steam dam of vessels of various diameters. The main body contains front and rear cameras used to visualize the path of the apparatus, and two NASA-type extending mast assemblies, which are capable of extending at a selected distance above and below the main body. The mast assemblies support inspection equipment such as radiation-shielded EVT-1-capable video cameras and radiation-tolerant fiberscopes. The apparatus, including the inspection tools, is remotely controlled via control consoles with video monitors from a low-dose, non-contaminated enclosure spatially located away from the BWR. For example, a Kelly building on the refueling deck may house the control consoles.

The apparatus disclosed herein provides a remotely controlled inspection vehicle capable of movement on the reactor steam dam without using any additional platforms for the vehicle and without modifying the existing BWR structures. This eliminates the need to use the refueling bridge, the auxiliary bridge or other specialized inspection platforms. The apparatus provides the ability to perform inspections independent of other critical path activities (e.g., core alterations), thus shortening the duration of outages and saving costs. And, the apparatus provides a stable platform for a variety of current and future inspection/maintenance devices.

### BRIEF DESCRIPTION OF THE DRAWINGS

FIG. 1A is a perspective view of an inspection apparatus in accordance with an embodiment of the present invention installed on a reactor steam dam.

FIG. 1B is a perspective view of a selected area from FIG. 1A.

FIG. 1C is a front view of the inspection apparatus of FIG. 1A.

FIG. 2 is a front perspective view of the inspection apparatus shown in FIG. 1A.

FIG. 3A is an exploded perspective view of a roller assembly in accordance with an embodiment of the present invention.

FIG. 3B is a perspective view of the pinch roller arm assembly in accordance with an embodiment of the present invention.

FIG. 3C is a side-exploded view of the drive roller assembly in accordance with an embodiment of the present invention.

FIG. 3D is an exploded perspective view of the pinch roller unit assembly in accordance with an embodiment of the present invention.

FIG. 3E is a cross-sectional view of the inspection apparatus of FIG. 1C positioned on the steam dam of a BWR.

FIG. 4 is a front view of the pneumatic manifold assembly in accordance with an embodiment of the present invention.

FIG. 5 is a side view of the intermediate tilt motor in accordance with an embodiment of the present invention.

FIG. 6A is a side view of the combined float can and guide tube assemblies in accordance with an embodiment of the present invention.

FIG. 6B is side view of the float can assembly in accordance with an embodiment of the present invention.

FIG. 6C is a perspective view of the 4-way articulation assembly of the fiberscope in accordance with an embodiment of the present invention.

FIG. 6D is a perspective view of the fiberscope bundle assembly in accordance with an embodiment of the present invention.

FIG. 7 is a perspective view of the up mast assembly in accordance with an embodiment of the present invention.

FIG. 8 is the pneumatic flow diagram in accordance with an embodiment of the present invention.

FIG. 9A is a cross-sectional view of the side view camera in accordance with an embodiment of the present invention.

FIG. 9B is an exploded cross-sectional view of a selected area from FIG. 9A.

FIG. 10 is a down mast inspection camera zoom/focus interface diagram in accordance with an embodiment of the present invention.

FIG. 11A is the control console I block diagram/flowchart in accordance with an embodiment of the present invention.

FIG. 11B is the control console II block diagram/flowchart in accordance with an embodiment of the present invention.

FIG. 12A a schematic view of a variable focal length fiberscope lens in accordance with an embodiment of the present invention.

FIG. 12B is a polychromatic diffraction modulation transfer function diagram of the lens shown in FIG. 12A.

### DETAILED DESCRIPTION OF THE PREFERRED EMBODIMENTS

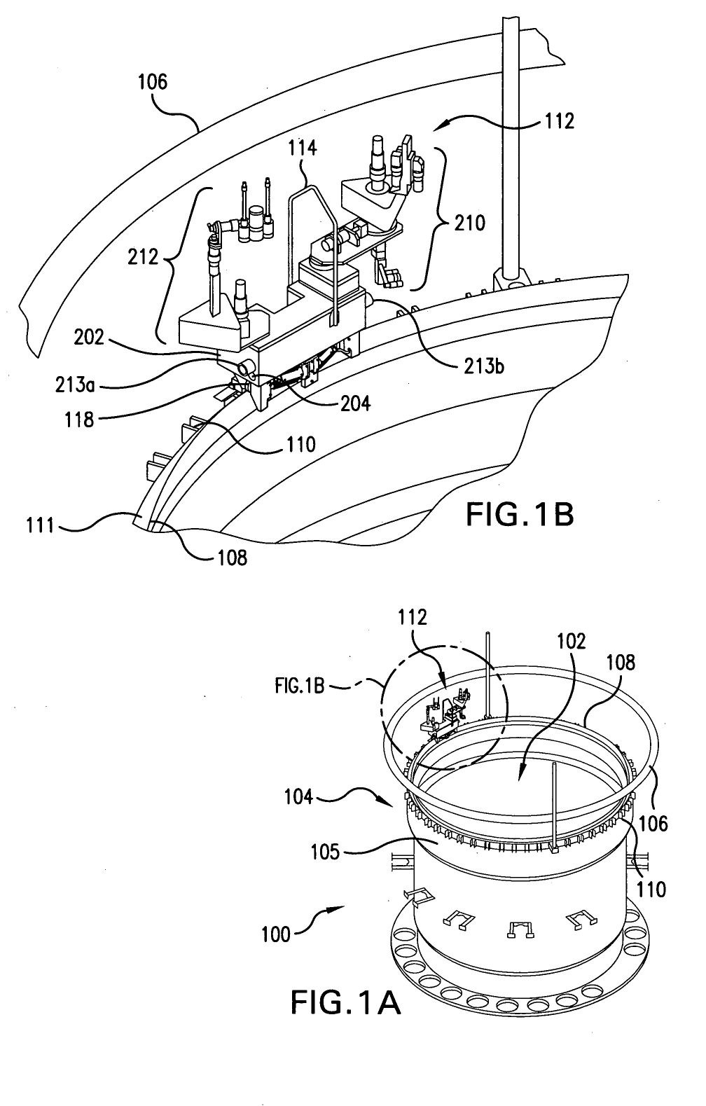

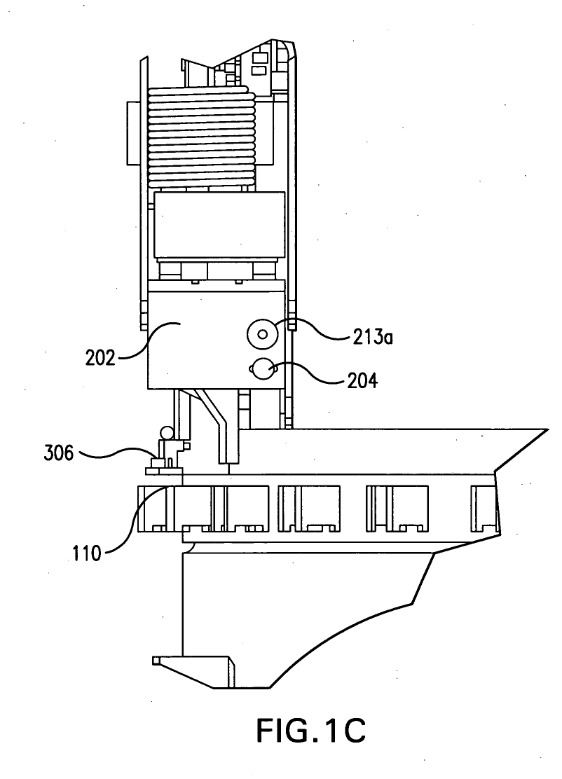

FIG. 1A is a perspective view of a BWR reactor vessel 100. The reactor vessel (also referred to as the Rx vessel) 100 includes a core region 102 and an annulus region 104, separated by a core shroud 105. Steam dam 108 is located above the core shroud 105, generally separating the core region 102 from the annulus region 104. The reactor vessel 100 also includes feedwater spargers and core spray piping 106, which provide coolant flow to the reactor vessel. The feedwater spargers and core spray piping 106 are located above the steam dam 108. A typical steam dam is ¼ of an inch thick and 4″ inches high. Slightly below the steam dam 108 are separator hold-down lugs 110. The hold-down lugs 110 are located adjacent to the core shroud flange 111. The hold-down lugs 110 hold down the steam separator (not shown).

FIG. 1B is a perspective view of a selected area from FIG. 1A and shows a preferred embodiment of an inspection apparatus 112 in accordance with the present invention. FIG. 1C is a front view of the inspection apparatus of FIG. 1A. Inspection apparatus 112 is shown positioned on the steam dam 108. The inspection apparatus 112 travels in a circular fashion on the steam dam 108, utilizing the steam dam lip to keep the device on radius as it moves around the annulus area 104. Advantageously, the inspection apparatus 112 does not require an additional reactor ring or other specialized inspection platforms in order to perform its functions. As described further below, the inspection apparatus 112 permits inspection of the in-vessel, annulus and surrounding areas of BWRs.

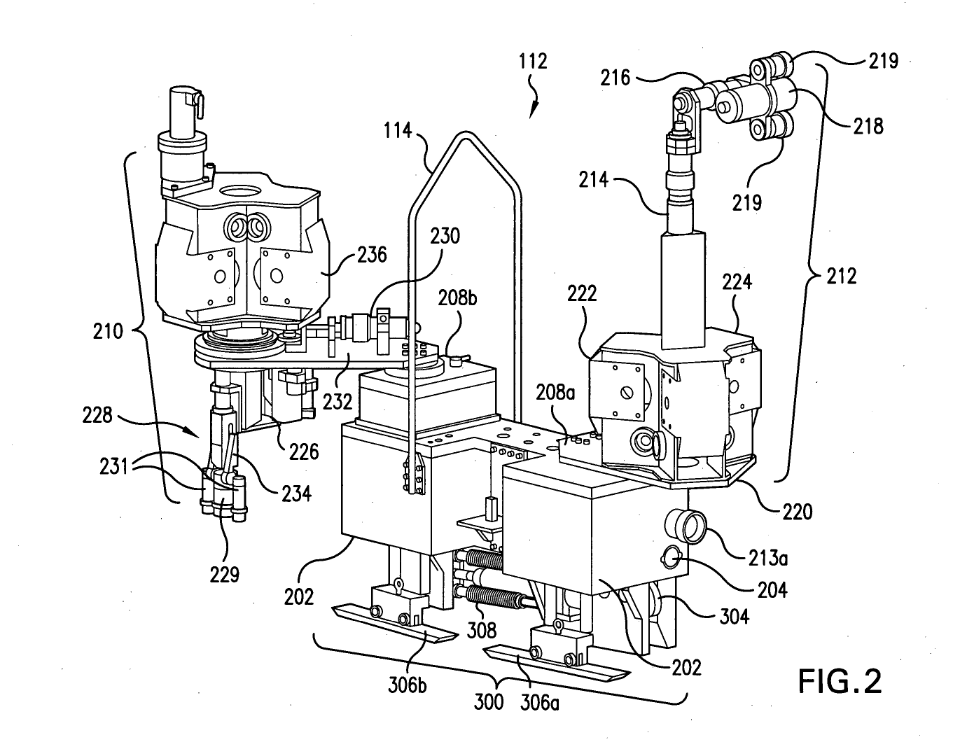

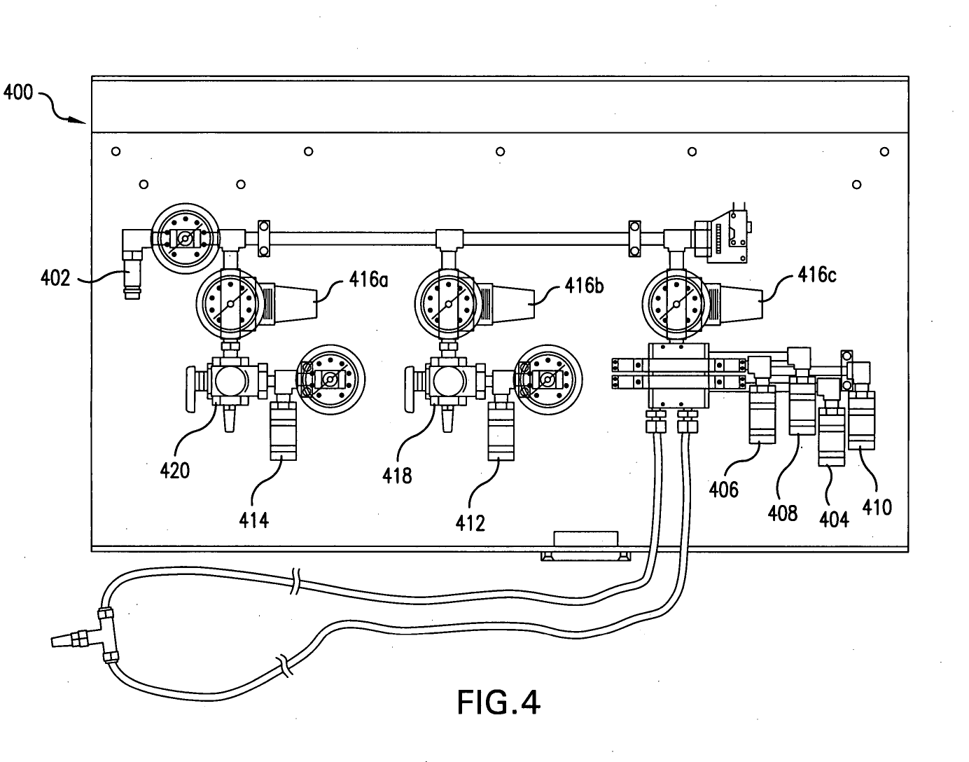

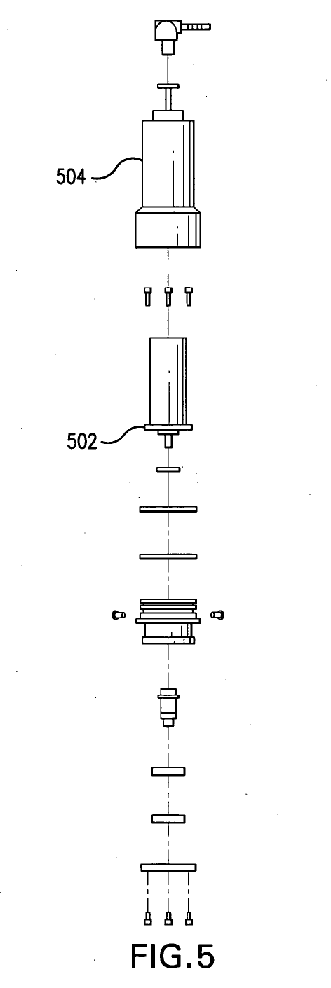

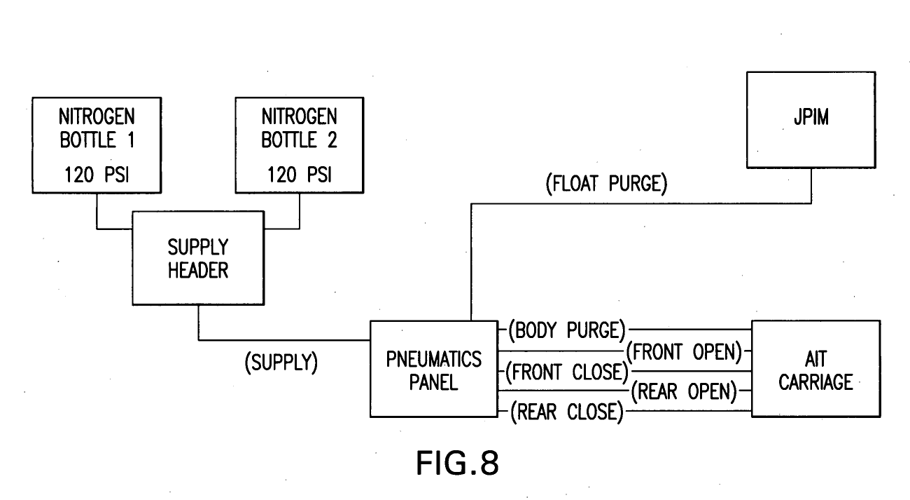

FIG. 2 is a perspective view of the inspection apparatus 112. The apparatus 112 has a main housing or carriage assembly 202 (also referred to as base unit), which is a generally rectangular-shaped component measuring approximately 2 ½ (length)×1 (width)×1 ½ feet (height) and weighing approximately 600 lbs in air. Preferably, the base unit 202 is formed with hard black anodized aluminum and stainless steel components and is watertight. The base unit 202 is made watertight by seals and by providing a continuous purge of nitrogen to maintain the internal pressure of the component slightly higher than the external pressure. Therefore, any leakage would be nitrogen leaking out of the base unit 202 instead of water leaking into it. The purge system, shown in FIG. 4 and FIG. 8, and discussed further below, uses nitrogen to maintain a positive pressure in the base unit and float chambers.

Advantageously, as described further below, the principles of the present invention allow for the 600 pound inspection apparatus to balance and move on a steam dam that is ¼ of an inch thick and 4″ inches high. Preferably, the base unit 202 is designed to support all of the camera and lighting fixtures contemplated by the present invention, as well as an additional twenty-five (25) pounds of static weight in anticipation of future accessory tooling.

With reference to FIG. 2, the base unit 202 preferably contains two cameras, one camera 204 in the front, and another camera (not shown) in the rear, to facilitate the operators' view for machine positioning and locomotion. Preferably, a 250 W wet light 213a is located in front and above camera 204 and provides the necessary lighting conditions for camera 204. And, an additional 250 W wet light 213b, is equipped with the rear camera 205 and provides the necessary lighting conditions for the rear camera 205.

The base unit 202 preferably has a bail weldment 114, which is attached to the opposite sides of the base unit. The bail weldment 114 is used to position the inspection apparatus 112 on the steam dam 108. A crane (not shown) uses the bail weldment 114 to lower the inspection apparatus onto the steam dam 108. After the apparatus 112 is finished with the inspection process, a crane uses the bail weldment 114 to lift the apparatus off of the steam dam.

Attached to the top side of the base unit 202 are two turret-type assemblies 208a and 208b for mounting of two ribbon lift mast assemblies, the down mast 210 and the up mast 212 (also referred to as mast 1 and mast 2, respectively). The masts may be outfitted to support a variety of inspection and maintenance equipment such as remotely operated ultrasonic testing probes, torque wrenches, jet pump internal plating removal tools, vacuum heads, grinders, welding equipment, and water jets.

The up mast 212 permits extension of inspection tools, e.g., cameras, for inspecting areas above the inspection apparatus 112. Conversely, the down mast 210 permits extension of inspection tools, e.g., cameras, for inspecting areas below the inspection apparatus 112. The two masts are preferably located at opposite ends of the inspection apparatus 112.

The up mast 212 is positioned on top of the turret 208a. The rotation of the turret 208a allows for the up mast 212 to rotate. An upper mast plate 220 sits on top of the turret assembly 208a and supports a ribbon lift. A ribbon mast 224, located above the ribbon shield 222, preferably supports a pedestal camera mount 214. The pedestal camera mount 214 has a pan and tilt assembly 216. A camera 218 is preferably mounted upon the pedestal camera mount 214. The camera 218 is capable of panning and tilting via the pan and tilt assembly 216. Attached to the camera 218 are two independently controlled, high-power lights 219. Lights 219 provide the necessary lighting for camera 218 to perform various inspections.

The down mast 210 is positioned on top of the turret 208b for rotation around the turret 208b. The down mast 210 contains a fiber drive 226, utilized to lower and raise inspection tools (not shown), such as a fiberscope or a side view camera. A ribbon lift shield 236, on the inside of which is a ribbon lift (not shown) is located above a mounting plate 232. A square yoke assembly 228 is located below the fiber drive 226 at the end of the down mast 210. The square yoke assembly 228 preferably includes a camera system 229 and two high-power lights 231. Positioned above the turret 208b is a mast frame with a rotate component 230. The rotate component 230 rotates the down mast 360 degrees.

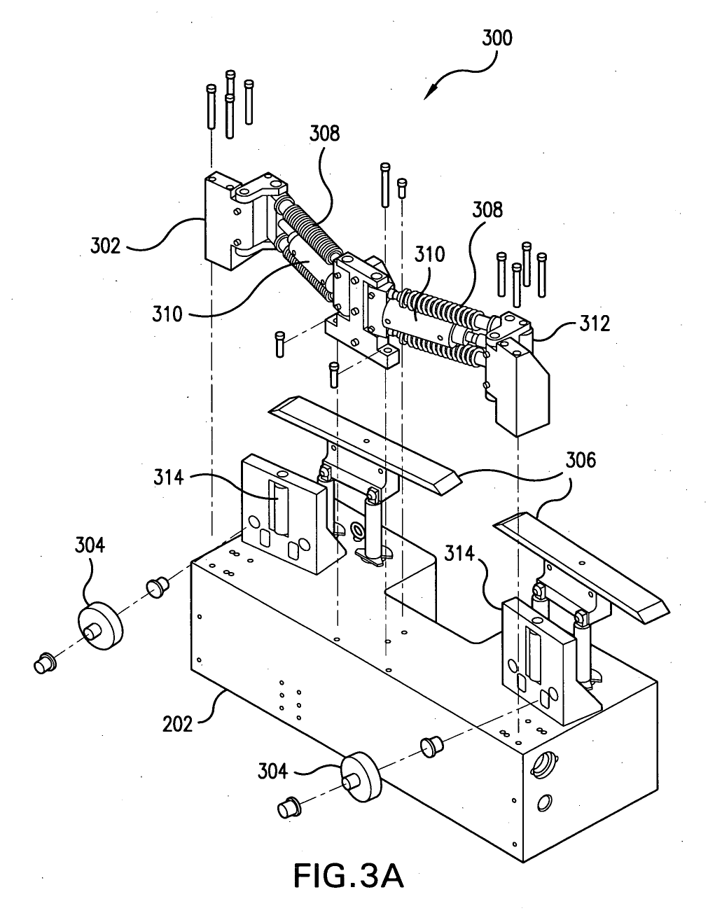

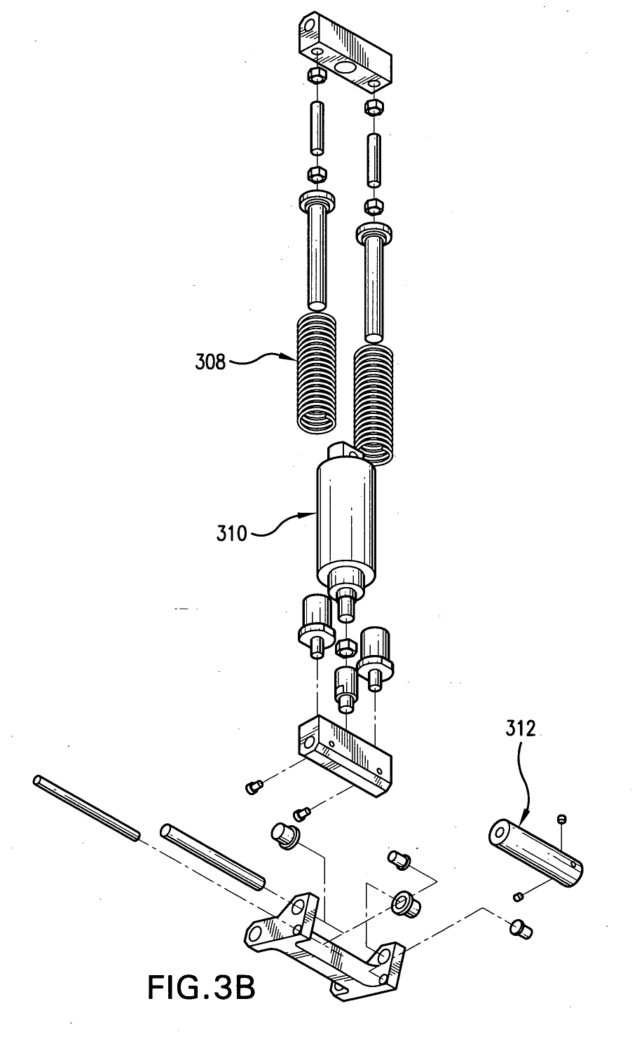

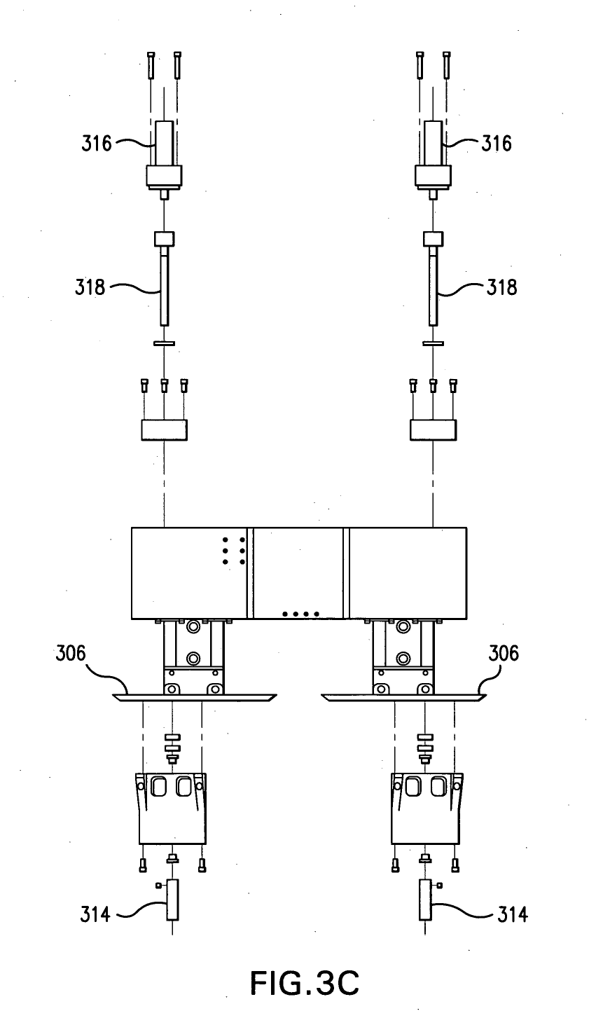

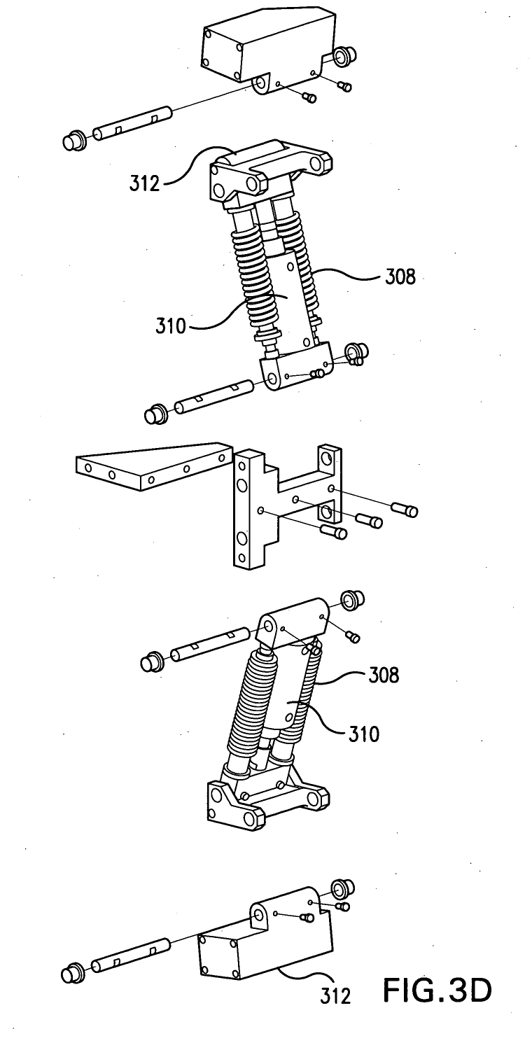

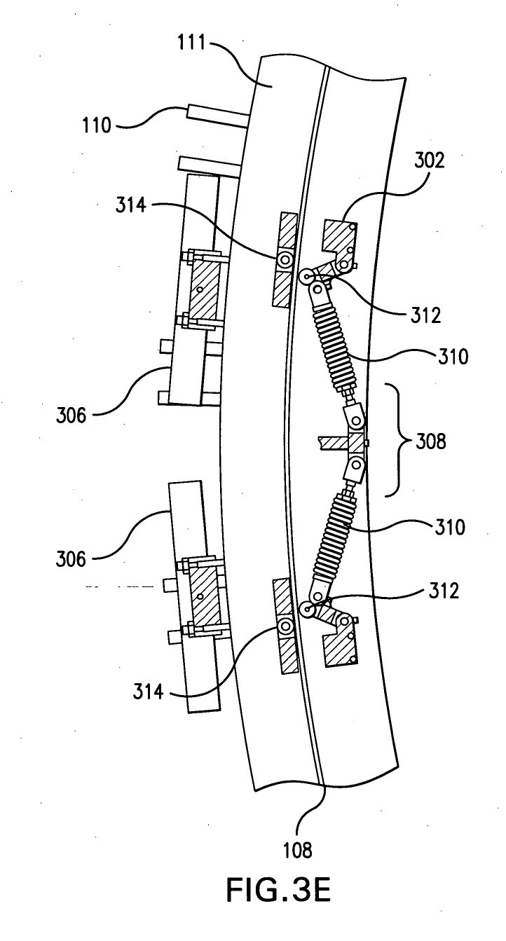

Located below the base unit 202 is the mechanism for propulsion, propulsion system 300, which is shown in more detail in FIGS. 3A-3D. The propulsion system 300 is attached to the underside of the base unit 202. Two skids or rails, a rear rail/skid 306a and a front rail/skid 306b, position and stabilize the base unit 202 on the steam dam. Located approximately in the middle and below the base unit 202 are two top dam rollers 304, shown in FIG. 3A. The top dam rollers 304 sit on top of the steam dam and support the weight of the inspection apparatus 112 as it moves around the steam dam 108. A high-tension spring clamp 308 is located under the base unit 202 and helps secure the inspection apparatus to the steam dam.

Locomotion

As discussed above, the inspection apparatus 112 is propelled with the system 300, which includes rollers and skids, best seen in FIGS. 3A and 3E. System 300 includes a pinch roller assembly 302 for frictional engagement with the steam dam lip 108. Top dam rollers 304 land on the top of the steam dam to support the weight of the apparatus when the inspection apparatus 112 is deployed on a steam dam 108. A rear rail/skid 306a and a front rail/skid 306b position and stabilize the inspection apparatus 112, especially when it is not moving along the steam dam lip 108 (i.e., when the inspection apparatus 112 is held in place to perform an inspection). The skids 306a and 306b rest on the hold down lugs 110. The hold down lugs 110 offer support for the inspection apparatus 112 on the annulus side 104 of a BWR. A high-tension spring clamp 308 helps secure the apparatus to the steam dam 108 with assistance from pneumatic air cylinders 310. The spring clamp 308 tensions two pinch rollers 312 against one side of the steam dam 108. On the side opposite the pinch rollers 312 is a set of driver rollers 314 to propel the machine. The pinch force can be increased by use of pneumatic air cylinders 310 to compensate for an uneven steam dam. The force provided by the springs 308 is continuous. By pressurizing pneumatic air cylinders 310 in one direction, the springs 308 are overridden, and the pinch rollers 312 open. That is, the pinch rollers 312 move away from the side of the steam dam 108, thus relinquishing their grip on the steam dam. If the air cylinders 310 are pressurized in the other direction, force is added to the already existing spring force, and the pinch rollers 312 pinch harder. That is, the pinch rollers 312 are forced to grip and engage the steam dam 108 tighter. The air cylinders 310 can also be vented so that the spring force alone closes the pinch rollers 312. The controls for this feature are located on a pneumatic manifold and on the control console. By decreasing or increasing the tension applied to the pinch rollers 312, the inspection apparatus is able to navigate along an irregularly-surfaced steam dam.

Preferably, top dam rollers 304 are approximately the load-bearing point and the center of gravity of the entire apparatus 112. When apparatus 112 is deployed, positioning rails or skids 306a and 306b are capable of extending to the hold down lugs 110 and help stabilize the apparatus on the steam dam 108. The skids 306 telescope as required for vertical and horizontal balance via linear drive actuators (not shown) to stabilize the apparatus 112 on the steam dam 108. The positioning skids 306 are used in the preferred embodiment of the invention but are not necessary to balance the apparatus 112 in every aspect of its use.

Two sets of rollers, the pinch rollers 312 and the driver rollers 314, are located on opposite sides of the steam dam 108 and grip the steam dam in a plane nearly perpendicular to the plane on which the top dam rollers 304 ride. The driver rollers 314 are each driven by a separate circumferential drive mechanism consisting of a motor 316 and a shaft assembly 318, as shown in FIG. 3C. The motor 316 rotates the shaft assembly 318, which spins the driver roller 314. Because there are two driver rollers, there are also two motors. The motors cause the driver rollers 314 to spin against the side of the steam dam 108, thus propelling the inspection apparatus along the steam dam. The motors are housed inside the base unit 202 and are powered by electricity, which enters the base unit 202 via an electrical power cord (not shown).

Mast Assemblies

The main component of each ribbon lift mast 210 and 212 is an assembly consisting of three individually coiled springs deployed via an electric motor. As these coils are deployed, the three sections interlock, creating a triangular mast approximately twenty-six (26) feet long. The resultant structure has a strong overall profile and allows minimal deflection. The preferred ribbon lifts utilized in each of the masts 210 and 212 are NASA-type ribbon lifts, modified purchase part from Ribbon Lift, Inc. (Model #1.5×26′). The ribbon lift consists of three stainless steel ribbons. Each ribbon is cut with angled slots down the center and with zipper-like teeth down the sides. A worm gear, positioned in the center of the three ribbons, drives the ribbons in and out. As the ribbons are extended the zipper-like teeth snap together, forming a triangular cross-section. The resultant structure has excellent vertical strength and fair lateral and torsional rigidity for its weight.

The preferred modifications to the ribbon lift are as follows. All materials are corrosion resistant. Preferably, stainless steel, aluminum or suitable substitutes are used. No grease or other lubricants are utilized. Hardened key stock is used. Cotter pins are not used in the ribbon lift. The ribbon material is approximately 0.025 inches in thickness. The edges of the ribbons are debured as much as possible. Standard stock top and bottom frame plates of 3/16 inch and standard stock side plates of ⅛ inch are used. The inside edge of the side plates is beveled to allow tabs to be guided in when coiling. Clearance between the coil and each side plate is 0.050 inches. Standard stock guide rollers are used. The reaction roller is below flush on the outside face of the frame plate. Standard stock drive shaft, worm and shaft are made as one unit. The drive shaft extends 2 inches beyond the bottom frame plate. The drive shaft is keyed with a 2-inch long keyway. The drive shaft has a nitrided case hardening finish. Open (unshielded) bearings are used where possible. The top frame plate where the mast emerges has a suitable clearance hole for the mast with “stress relief” type clearance holes in comers of the triangular hole. Each unit is cycled 20 times to full extension, and the peak torque found on the last cycle must be less than or equal to 5 ft-lbs.

The down mast 210 is positioned for vertical travel below the main body 202, in the z-direction, and the up mast 212 is positioned for vertical travel above the main body 202, in the z+direction. Each mast is mounted with brackets to the turrets 208 located on the top of the base unit 202. These turrets permit either mast to be pivoted in the xy plane, allowing each mast to be accurately positioned on either side of the base unit 202 (i.e., over the reactor vessel core area 102 or annulus area 104).

The down mast 210 is preferably capable of extending approximately twenty-six feet into BWR core 102 and can deliver many different small inspection tools, for example, a fiberscope or side view cameras. Collectively these inspection tools are referred to as the jet pump inspection modules (“JPIM”). This name derives from the fact that the down mast 210 is used to inspect the jet pumps located in the core region 102 of the BWR. Preferably, at the end of the down mast 210 is a camera system 229 capable of EVT-1 inspections, with zoom and focus control, tilt control, and high power underwater lights 231, which are all capable of being independently controlled. The down mast 210 is capable of 360° horizontal rotation in the xy plane. This rotation is achieved with the aid of a rotate motor 230 positioned between the mast assembly and the mounting plate 232.

The down mast 210 is attached to the turret 208b. A mast rotate component 230, rotates the mast 360 degrees. This rotation is separate and in addition to the pivoting of the entire down mast assembly 210 about the turret 208b.

The ribbon lift of the down mast is powered by an electric motor (not shown) similar to most other motors used on the inspection apparatus. The motor is preferably located in a waterproof container. Waterproof compartments of the inspection apparatus are sealed in a bath of a porosity sealant. Parts of the side-view camera 900, discussed later, such as camera housing 902 and rotational camera section 916 are also submerged or painted with LOCTITE 290 or its equivalent. The container or housing is preferably split into front and rear sections. The rear housing has a connector used to power the motor, and the front housing is where the shaft exits. The shaft is sealed with two lip seals manufactured by Macrotech Polyseal, Inc. (model #s M-8812-5 and M-9149-5). Although these lip seals are used to seal the shaft, any other lip seals commonly used in the industry may be used. The two sections are sealed together with two o-rings. The electric motor powers a gear train that rotates a ribbon lift on a set of bearings.

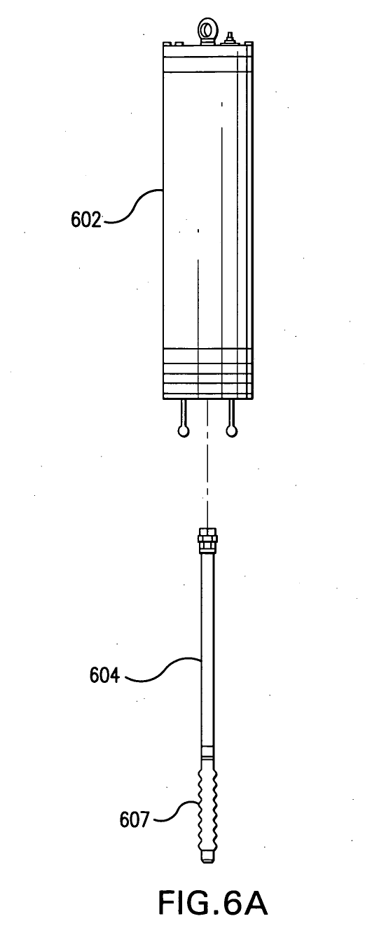

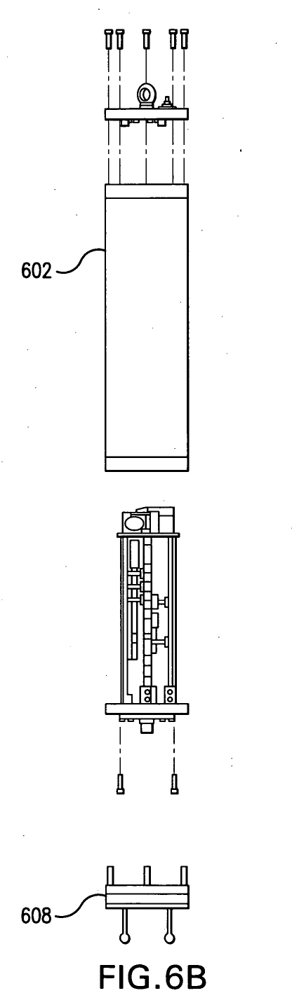

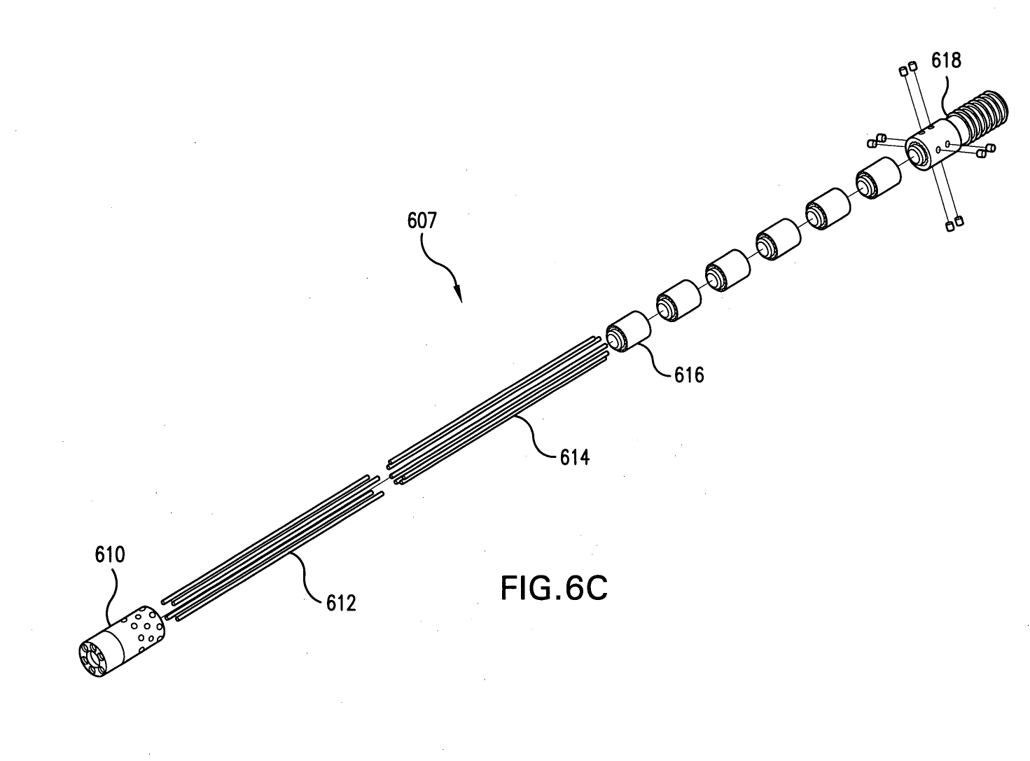

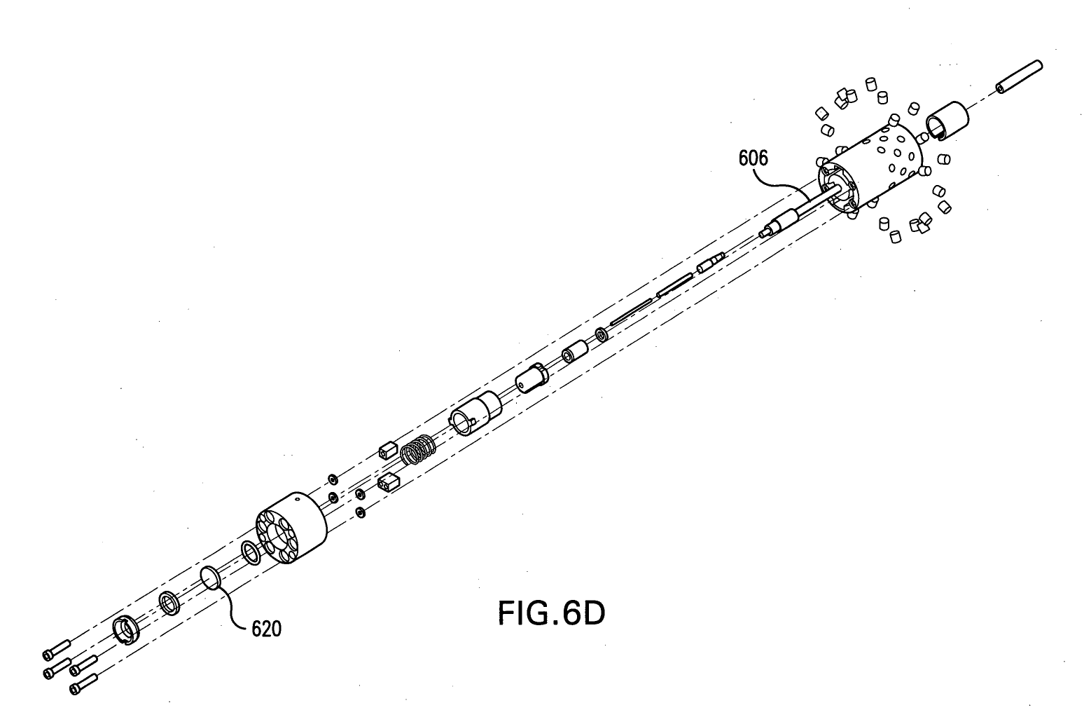

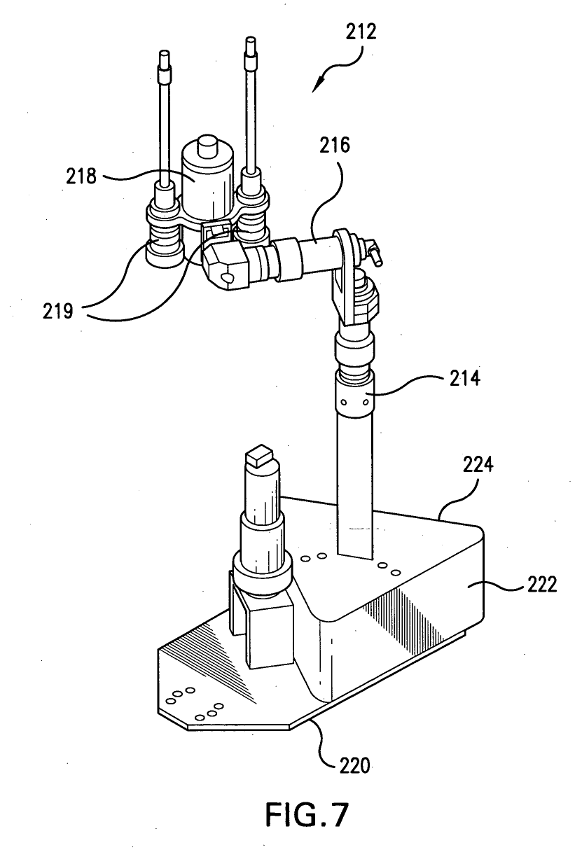

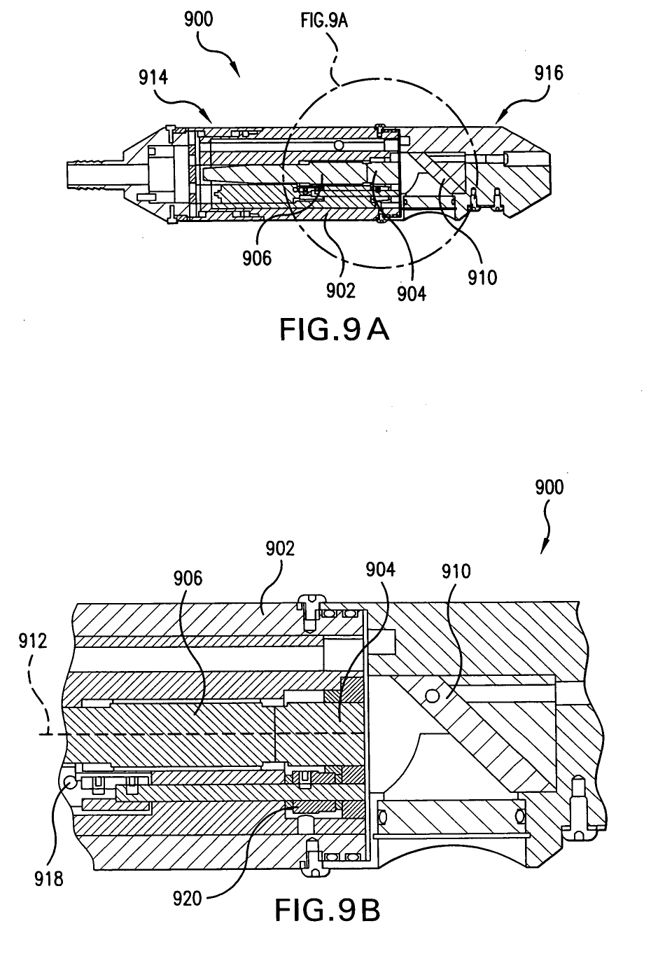

As previously mentioned, the down mast 210 includes the jet pump inspection modules 228. While the jet pump inspection modules may include any equipment useful in inspecting the jet pumps, the preferred embodiment of the invention includes a float can/chamber, a guide tube, a fiberscope or a fiberscope bundle, and a side view camera. FIGS. 6A and 6B depict a float chamber/can 602, which houses a camera to provide a relatively low-dose radiation environment for the camera. The float can 602 floats in the water, thus largely avoiding the high levels of radiation exposure found at greater depths of a BWR. A guide tube 604 extends downwardly from the float can 602 and houses a fiberscope (not shown). The fiberscope bundle 606, shown in FIG. 6D, has independently controlled lights (not shown) at the distal end. The preferred float can 602 is approximately 8″ in diameter by approximately 36″ in length. The preferred guide tube 604 is approximately 1″ inch in diameter by approximately 30″ in length. Preferably, the float can 602 weighs about 3 lbs. and is positively buoyant in deminiralized water, thereby keeping the fiberscope vertical. Located inside the float can 602 is a high resolution color camera, two articulation drive units and electronics for the lights. The buoyancy adjustment is preferably done with weights 608 attached to the outside of the float chamber 602. The pneumatic manifold, shown in FIG. 9, regulates the gas pressure to maintain approximately 5-psi positive pressure in the float chamber 602 at any given depth of water. Table 1 below lists the pressures required to be maintained inside the float chamber 602 at certain depths in order to achieve 5-psi positive pressure when the float chamber is lowered inside the water-filled core region of a BWR:

TABLE 1

| Depth (ft) | PSI |
|---|---|
| 0 | 5 |
| 10 | 10 |
| 30 | 20 |
| 60 | 30 |

The distal end 607 of the preferred guide tube 604, shown in FIG. 6A, points the fiberscope in a particular direction. Six articulation links 616 with ball and socket-style joints join with an interface link 618 and an end assembly 610. Four springs 612 run through small holes in the links and are attached at the end links to keep the assembly in tension. Eight additional springs 614 run through all the links to guide electrical wires to the end assembly for the independently controlled lights (not shown). Four high-tensile wires, termed the articulation wires, run through the remaining holes and are attached at the end assembly 610. The distal end of the articulation wires and the articulation end assembly 610 are driven by two articulation drive units, one for the x-direction, and one for the y-direction. These drive units (not shown) are preferably located in the float chamber 602.

The fiberscope is intended for use in tight areas, such as jet pump internals. The entire fiberscope bundle is 30 feet long. The fiber bundle preferably has about 30,000 to 50,000 individual fibers made of a radiation-tolerant quartz in a polyurethane sheath. A preferred fiber bundle and lens are available from Myriad, Inc., Part Number 20-0099-C-VT-30. The fiberscope allows the radiation-sensitive equipment, the camera and other electronics, to be in a low dose field inside the float chamber 602. The fiberscope is joined to the camera contained inside the float chamber 602 through a series of lenses used to magnify and focus the fiber image. In an alternate embodiment, the fiberscope is EVT-1 qualified.

The fiber bundle 606 preferably has sapphire lenses at the distal end for scratch and radiation resistance. Preferably, the distal end of the fiberscope is capable of 90 degrees of movement in any direction from the vertical down position, thus achieving a hemispherical viewing area (i.e., the distal end of the fiberscope is moveable from a position perpendicular to the BWR core “floor” to a position horizontal to it, and the fiberscope may be rotated 360 degrees).

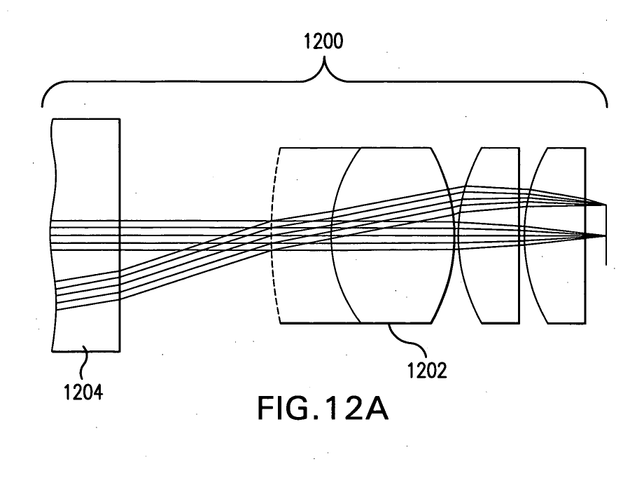

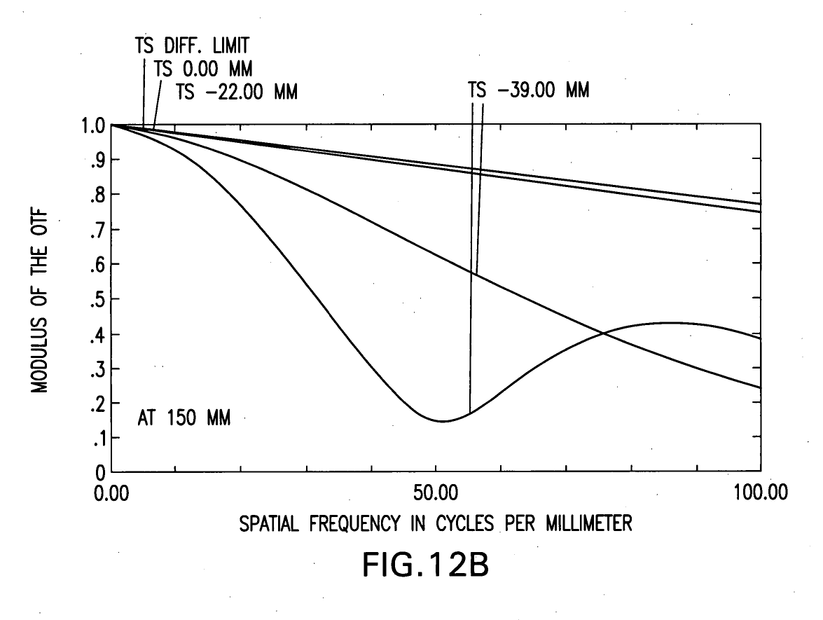

In one embodiment of the present invention, the fiberscope bundle 606 is equipped with a fixed focal length lens 620, shown in FIG. 6D. In an alternate, preferred embodiment, the fiberscope utilizes a variable focal position/length lens 1200, depicted schematically in FIG. 12A. A polychromatic diffraction modulation transfer function diagram of a preferred variable focal position lens is shown in FIG. 12B. Both the fixed and variable focal length lenses attach to the distal end of the fiberscope bundle 606 and are marked as lens 620 in FIG. 6D. Thus, lens 620 may be interchanged with either a fixed focal length lens or a variable focal length lens.

Unlike the fixed focal lens, the variable focal length lens 1200 is capable of changing field of view and depth of field of an observed area. The variable lens 1200 is controlled from the control console via pneumatic pistons. Preferably, the variable lens 1200 has two settings: (1) a close-up, detailed view of a selected area (for example, from ⅜ of an inch to 2 inches), and (2) a large field of view (for example, from infinity). For example, the doublet 1202 of the lens 1200 is moved in relation to the lens window 1204 in order to achieve near focus. The first setting provides a close-up, detailed view from ⅜ to 2 inches away, while the second setting provides a large view from approximately 20 feet away. The variable lens focal distances function in accordance with the description provided in Table 2, which also provides the window to doublet ratios.

TABLE 2

| Object Distance | Window (1204) to | |
|---|---|---|
| (mm) | Doublet (1202) ratio | Field Diameter (mm) |
| 153 | 2.40 | 78 |
| 100 | 1.70 | 50 |
| 50 | 0.40 | 25 |
| 15 | 0.25 | 6.8 |
| 12 | 0.10 | 5.0 |

In a preferred embodiment of the invention, variable lens 1200 has an aperture (AP) stop 0.5 mm nominal diameter, a basic focal length (BFL) of 0.37 mm, an F-stop of F/3.1 mm, and a focal length (F) to diameter (D) ratio of 4.5 to 3.0. Preferably, the lens window 1204 is made out of sapphire. While the above is an example of a preferred embodiment, other fixed and variable focal length lenses may be utilized with apparatus 112 in accordance with the present invention.

The side view camera 900, a cross section of which is shown in detail in FIGS. 9A and 9B, is used for the majority of annulus inspections. The side view camera 900 may be used in place of the fiberscope. Preferably, one of two different size cameras are used interchangeably, a 2″ diameter camera and a 1-⅜″ diameter camera. Preferably, the side view cameras are high-resolution color cameras. The side view cameras are generally shielded from radiation by placing the camera in a tungsten housing 902. Radiation shielding in the camera housing (and in other shielded parts of the apparatus) is preferably achieved with tungsten. The preferred shielding is a machinable tungsten alloy, preferably with no less than 90% tungsten. In comparison to lead, tungsten offers roughly twice the shielding per unit thickness. Because tungsten is more dense than lead, tungsten shielding advantageously provides for greater protection from radiation and allows for smaller parts and components to be utilized. The porosity in the tungsten is sealed with a bath of a porosity sealant such as LOCTITE 290.

The 2″ camera model has more shielding but is otherwise similar to the 1-⅜″ model. In general, both cameras are preferably modified in the following manner. An Elmo camera module #UM43H is paired with an Elmo lens #TT2011. The lens 904 threads unto the camera module 906. A lock ring (not shown) is then glued to the end of the lens 904 thereby extending the length of the lens. The extension of the lens through the lock ring modifies the manufactured lens to provide a focal distance of less than one inch.

Preferably, both cameras have a pan function, driven by a pan motor (not shown), two independent high intensity underwater lights integrated into the device, fixed zoom and adjustable remote focus. A camera module 906 is positioned looking at an elliptical mirror 910 tipped 45 degrees from the camera vertical axis 912. This mirror 910 reflects the image but not radiation, thus allowing the camera to be shielded from all directions. Side view camera 900 has a stationary section 914 and a rotational section 916. In the rotational section 916, the camera module 906, lens 904 and elliptical mirror 910 rotate together along the camera vertical axis 912. The rotation of the camera module 906, lens 904 and elliptical mirror 910 allows for superior image quality. The rotation of the camera module, lens and elliptical mirror is controlled from the primary console. The focus motor 916 drives a gear 918 and controls the camera focus.

Separately driven, the fiberscope or side view cameras 900 can be extended or be retracted by fiber drive 226. The fiber drive 226 is located below the mounting plate 232 and deploys the fiberscope or the side view camera 900.

In addition to the fiberscope and the side view camera 900, mounted to the lower end of the down mast 210 is a tungsten-housed radiation-shielded color camera 229 with individually controlled lights 231 mounted to a tilt unit 231. The lights 231 are preferably exposed to the surrounding water to cool the bulbs, thus preventing thermals and overheating.

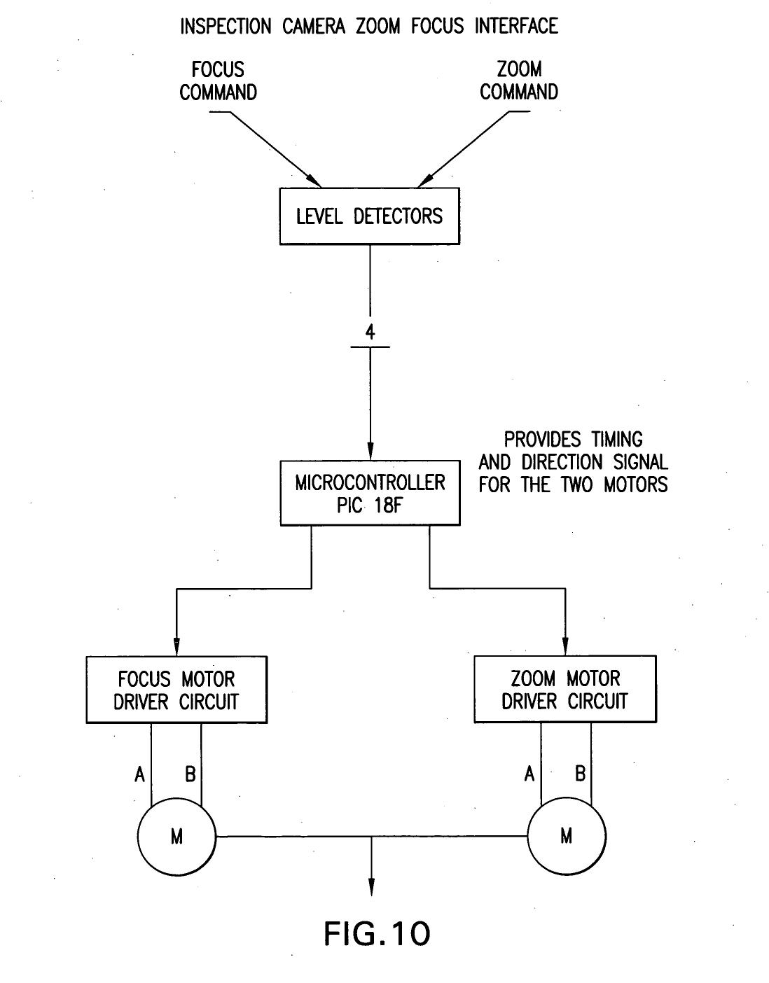

The preferred lens block used in camera 229 has 10× adjustable zoom and an adjustable focus. The zoom and focus are adjusted according to the flow diagram shown in FIG. 10. Stepper motors M adjust the lens block. Camera 229 is used for general area viewing, as an inspection camera, and to assist in positioning the fiberscope or the side view cameras 900. The down mast assembly 210 is used to inspect components below the steam dam, such as the reactor annulus region 104, jet pumps, the core shroud 105 and the core spray spargers. Other Rx vessel components may also be inspected.

The up mast 212 is designed to view areas located above the base unit 202. The up mast 212 is preferably capable of extending approximately twenty-six (26) feet up from the top of the base unit 202. Preferably, mounted at the end of the up mast 212 is a pan and tilt camera 218 capable of EVT-1 inspections, with zoom and focus control, and high power lights 219 capable of independent control.

Including the camera system 218, the up mast 212 has four degrees of freedom. The up mast 212 utilizes a ribbon lift identical to that of down mast 210. The ribbon lift used in the up mast 212 provides one degree of freedom in the “z” direction. The up mast 212 mounting plate 220 can rotate on the turret 208a located on top of the base unit 202, thus providing a second degree of freedom. The third and fourth degrees of freedom are from the pan and tilt assembly 216, which provides pan and tilt functions to camera 218. Unlike the down mast 210, the up mast does not have a rotate function. The pan mechanism 216 of the camera 218 located on the top of up mast 212 provides the rotate function. The pan with 360 degrees of rotation and tilt with 315 degrees will position the camera in any required direction.

Camera 218 preferably has 24× zoom and an adjustable focus. The camera 218 is not shielded due to the expected lower radiation dose field as compared to the anticipated larger radiation dose field present in the vicinity of camera 229. Preferably, camera 218 is EVT-1 qualified. A circuit for the camera control takes standard control signals and communicates to the camera using Sony VISCA command codes via TTL.

The mast 212 and camera system 218 are specifically designed to inspect components above the steam dam 108. These components include the core spray piping, feedwater spargers 106 and reactor vessel identification items located above the annulus area. Other Rx vessel components located above the steam dam 108 and not specifically mentioned herein are also capable of being inspected by the equipment mounted on mast 212.

Masts 210 and 212 are identical in the sense that both incorporate a ribbon lift, which provides up and down, or “z” axis motion. The z+ and z-movement in the ribbon lift is provided by a heavy-duty turning mechanism.

Main Housing/Base Unit Contents

The base unit 202 houses most of the equipment needed to operate inspection apparatus 112. Mounted on board the base unit 202 are calibration cards to aid in quickly and easily qualifying the inspection cameras to EVT and/or VT standards. The base unit 202 houses the circumferential drive mechanism that propels the driver rollers 314. Also contained within the base unit 202 are the front and rear skid/guide rail motors and the down and up mast turret motors. Circuitry and the electrical control wiring are also located inside of the base unit 202. This circuitry and wiring include the ribbon lift power supply and control circuits, the down mast camera CCU, the down mast camera zoom and focus control board, the down mast camera tilt control wiring, the down mast rotate control wiring, the wiring for the down and up mast camera lights, wiring for the up mast camera pan and tilt motors, wiring for the up mast camera, circuitry for the front and rear body lights and cameras, and pi filters to reduce electrical noise in the DC voltage supplied to the cameras.

Cables

A collection and arrangement of cables, referred to as umbilical cords, is used in the present invention to increase signal optimization. The cables are used to connect the control consoles to the main body and float cans and are utilized to provide electrical power and to relate information and commands to and from the inspection apparatus. Two types of cables are used. Both cables are constructed using mating connectors that allow them to be connected end to end. This arrangement allows for additional cables to be added when extra length is required. The first cable is a neutrally buoyant cable with a polyurethane outer jacket. This cable includes 35 conductors made up of a combination of 75 Ohm coax, twisted shielded pairs and one quad twisted wire. Preferably, the conductors are arranged with fillers to produce a round cable that has a density of about 1.0 grams per cm³ in fresh water. The twisted shielded pairs provide isolation between the conductors to reduce electrical noise in the system. This cable is used for connection to the main body and float chamber and is submersible.

The second cable has the same number of conductors as the first cable. This cable is not constructed with the same fillers that are used in the submersible cable. This cable is not buoyant in fresh water. This cable is used to extend the length of the system cables from the BWR cavity to the control consoles.

Control System

In a preferred embodiment, the inspection apparatus is remotely operated from a low dose, non-contaminated enclosure located away from the BWR. A Kelly building on the refueling deck is a preferred location for remote operation. A control station is preferably used by an operator to remotely control inspection apparatus 112. The preferred control station preferably includes four consoles—two inspection apparatus control consoles, a record/monitor console and a computer console. Additional control consoles may be added to operate other equipment, for example, viewing cameras, such as the reactor stud-mounted cameras. The stud-mounted cameras are independent of the inspection apparatus and are used to provide viewing information regarding the location of the vehicle and its equipment. Although the stud-mounted cameras may aid in providing a view of the inspection apparatus, they are not essential to the present invention. The control consoles used by operators of inspection apparatus 112 preferably include high-resolution monitors with video, DVD and graphic capabilities.

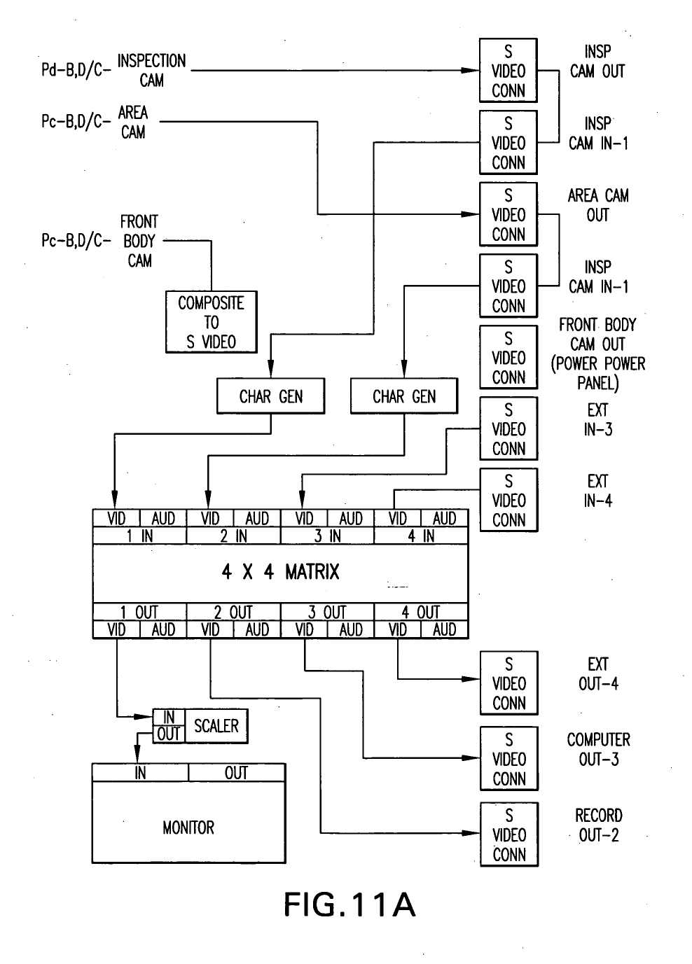

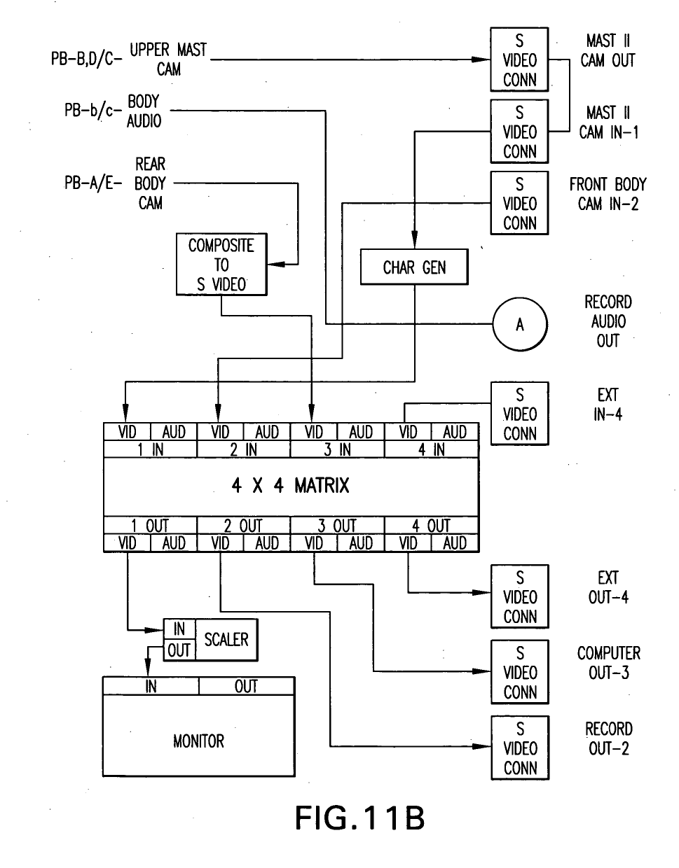

The two control consoles provide standard function control. Preferably, the control consoles also provide video conditioning and switching, as shown in FIGS. 11A and 11B, which show the video signal flow paths.

In a preferred arrangement, control console I operates the down mast 210, the fiber drive 226, and either the fiberscope or the 1-⅜″ or 2″ inch radiation tolerant side view camera 900. The control console I is comprised of a 16″ space console with a BTX 4×4 video matrix, two character generators and a high resolution 17″ LCD monitor. The console has been configured to support s-video. The character generators are configured with a loop through on the rear panel. This allows the inspection video to be preprocessed by optional devices before adding titles. This console has two 37 P Amphenol connectors for interconnecting with the main body and the float chamber.

Above the controls is a meter panel assembly with LEDs. This monitors the amperage to selected motors. When a motor reaches a preset amperage, the current limiting board (“CLB”) will trip and switch off voltage to the motor. When a motor is running, the ammeter will display the amount of amperage draw. If a motor reaches its amperage limit, the CLB will trip and the red LED will light. When the toggle switch is released the CLB resets itself automatically so that a motor may then be run in the opposite direction. The controls for control console I are found in Table 3 below.

TABLE 3

| Function | |
|---|---|
| Controlled | Description |
| JPIM feed | The JPIM feed toggle switch controls the JPIM feed up or |
| | down from the end of the down mast. |
| Down mast | The down mast general area camera zoom toggle switch |
| zoom | allows the operator to view an object closer. |
| Down mast | The down mast general area camera focus toggle switch |
| focus | allows the operator to manually focus the camera view |
| | throughout the zoom range. |
| Down mast | The right and left down mast inspection camera lights are |
| left & right | individually controlled. A toggle switch turns the light on |
| lights | and a rotary switch controls the light intensity. |
| Down mast | The down mast feed toggle switch feeds the down mast up |
| feed | or down. |
| Down mast | The down mast turret 208b toggle switch controls the |
| turret 208b | swing of the down mast to the core side or annulus side of |
| | the steam dam. |
| Down mast | The down mast rotate toggle switch controls the panning |
| rotate | motion of the down mast assembly clockwise (CW) or |
| | counter-clockwise (CCW). |
| JPIM release | The JPIM release key switch turns left to open the fiber |
| | drive, releasing the JPIM, or right to close, clamping the |
| | JPIM in the fiber drive assembly. |
| JPIM tilt-y | The JPIM tilt-y and x toggle switches control the |
| and tilt-x | articulation of the JPIM in the y and x planes, respectively. |
| JPIM brush | The JPIM brush is an option to turn a cleaning brush on or |
| | off. |
| JPIM left & | The two light arrays at the end of the JPIM are individually |
| right lights | controlled. The respective toggle switch turns the light on |
| | and the respective rotary switch controls the light intensity |
| | and video channel. |

In the preferred arrangement, control console 2 operates the up mast, the main housing, the skids and the drive roller assembly. Control console 2 is comprised of a 16″ space console with a 4×4 video matrix, one character generator and a high resolution 17″ LCD Monitor. The console has been configured to support s-video. The character generator is configured with a loop through on the rear panel. This allows the inspection video to be preprocessed by optional devices before titling. This console has one 37 P Amphenol connector for interconnecting with the main body and a 14 P Amphenol connector to interface with the air control panel. Above the controls is a meter panel assembly with LEDs. This panel measures the amperage to selected motors. When a motor reaches a preset amperage, the current limiting board (CLB) will trip and switch off voltage to the motor. When a motor is running, the ammeter will display the amount of current draw. If a motor reaches its amperage limit, the CLB will trip and the red LED will light. When the toggle switch is released, the CLB resets itself automatically so that a motor may then be run in the opposite direction. The controls for control console 2 are found in Table 4 below.

TABLE 4

| Function | |
|---|---|
| Controlled | Description |
| Up mast | The up mast camera tilt toggle switch controls |
| camera tilt | the camera and lights tilt up and down. |
| Up mast pan | The up mast pan toggle switch controls the camera |
| | and lights panning motion left and right. |
| Up mast | The up mast turret toggle switch controls the |
| turret 208a | swing of up mast to the core side or annulus |
| | side of the steam dam. |
| Up mast | The up mast camera zoom toggle switch allows |
| zoom | the operator to view an object closer. |
| Up mast | The up mast camera focus toggle switch allows |
| focus | the operator to manually focus the camera |
| | view throughout the zoom range. |
| Up mast | The up mast feed toggle switch feeds up mast |
| feed | either up or down. |
| Pinch roller | The pinch roller drive joystick controls the main |
| drive | housing drive direction forward (joystick right) |
| | or backwards (joystick left) along the steam dam. |
| Up mast left | The two up mast camera lights are individually |
| & right | controlled. The respective toggle switch turns |
| lights | the light on and the respective rotary switch |
| | controls the light intensity. |
| Main housing | The main housing lights at each end of the base |
| lights | unit are controlled together. The toggle switch |
| | turns the lights on and the rotary switch controls |
| | the light intensity. |
| Front and | The front and rear skid toggle switches raise |
| rear skids | or lowers the front or rear skids, respectively, |
| | up or down. |
| Front and | The front and rear pinch roller key switches open |
| rear pinch | or close the front and rear pinch roller assemblies |
| rollers | on the steam dam. The key switches positions from |
| | left to right are open, close, and clamp. The keys |
| | may be removed in the closed position to prevent |
| | tampering. |

In the preferred arrangement, the record/monitor console is comprised of a 16″ space console with a DVD recorder, a video scaler, 4×4 video matrix, a high resolution 17″ LCD monitor, and a pull-out keyboard for on screen title annotating. The console is preferably configured to support s-video and mono audio only, but may easily be adapted to support other video types and stereo audio. There are two A/V inputs and one A/V output.

The video scaler is used to alter the image on the LCD monitor in the record console only. The video scaler does not alter the video recorded to VCR and/or DVD. The functions used are video zoom and pan of the display image.

Computer Console

The computer console provides an on-site solution for video capture, documentation, and includes both motion video and still image processing. The console includes a rack-mounted personal computer, monitor and power switch. The preferred configuration is installed in an eight inch space rack mount environmental case. In this configuration, the computer has an Intel P4 processor, 1 gigabyte of DDR RAM, two 120 gigabyte IDE hard drives, DVD +/− RW drive, modem and the ATI All-in-Wonder 9800 series AGP Video card. The system software is Microsoft Windows XP professional, Microsoft Office XP with publisher, Norton Systemworks, Roxio EZ Media Center and Ulead Media Pro with Studio Quartet. Other components are mouse, keyboard and a Hewlett Packard model 7960 printer. The s-video from the system consoles is routed through a video switch attached to the media input.

Purge System

FIG. 4 shows the front panel of the pneumatic manifold assembly 400. With reference to the front panel shown in FIG. 4 and the flow diagram shown in FIG. 8, the following provides details of the purge system connections in accordance with an embodiment of the present invention. Two regulators on two nitrogen bottles are installed. The line gauge is labeled with an arrow pointing to 120 psi for ease of visual inspection. The lines are connected from the shut-off valve to the tap on each regulator. A pneumatic extension cable of 125 feet is connected to console 2 connection labeled “pneumatic extension” and extended to the C-Zone barrier.

The pneumatic manifold assembly 400 is mounted to the reactor handrail near the apparatus installation point. A 125′ pneumatic hose is connected to the quick disconnect 402 of the pneumatic manifold assembly. A 125′ pneumatic extension cable is connected to the connector of the pneumatic manifold assembly. At the C-zone barrier (contaminated zone C), the pneumatic hose is connected to the quick disconnects 402 and the pneumatic extension cables together. From the sleeved main umbilical harness assembly, the pneumatic line is connected in the following manner: “rear open” is connected to the port “rear open” 404 on the pneumatic manifold; “rear close” is connected to the port “rear close” 406 on the pneumatic manifold; “front close” is connected to the port “front close” 408 on the pneumatic manifold; “front open” is connected to the port “front open” 410 on the pneumatic manifold.

If desired, the “body purge” line is connected to the port “body purge” 412 on the pneumatic manifold 400. Also if desired, the “float purge” line is connected to the port “float purge” 414.

The pinch roller regulator 416c is adjusted to 120 psi. The body purge shut-off valve 418 is positioned in the exhaust position, and the body purge regulator 416b is adjusted to 5 psi. The body purge shut-off valve 418 is opened, and the full length of the line is checked for leaks. The float can is preferably set to pressures shown in Table 1, above. The adjustments are made via the float purge regulator 416a and the float purge shut-off valve 420. The supply line pressure should not drop below 90 psi.

Operation of the Inspection Apparatus

Preferably, the inspection apparatus 112 is deployed in the following manner. A crane, attaches to the bail weldment 114 of the inspection apparatus 112 and lowers the inspection apparatus onto the steam dam 108. RSTs remotely control the inspection apparatus from a low-dose, non-contaminated enclosure, such as a Kelly building on the refueling deck, causing the apparatus to move around the steam dam 108 to a specified location to perform a desired inspection. RSTs utilize the front camera 204 and rear camera 205 via the control consoles to help position the inspection apparatus at a specified location on the steam dam. Once the inspection apparatus stops moving, the guide rails 306 may be lowered onto the separator hold down lugs 110 to provide additional support and balance for the inspection apparatus.

Depending on the nature of the desired inspection, either the up mast 212 or the down mast 210 are then utilized. For example, the ribbon lift of the down mast 210 lowers the fiberscope to inspect areas located underwater in the core section 102 of a BWR. After performing the desired inspection, the ribbon lift raises the fiberscope. At this point, the inspection apparatus may be moved to another location on the steam dam. Once all desired inspections are performed, the inspection apparatus is removed with a crane.

1. An apparatus for inspecting the core and annulus regions of nuclear boiling water reactors, the apparatus comprising:
a carriage assembly containing electrical control wiring;
a propulsion system for propelling the apparatus, the propulsion system being mounted on the underside of the carriage assembly, wherein the propulsion system comprises a spring-loaded drive assembly having a plurality of rollers adapted to rest on top of the reactor steam dam, a pinch-roller assembly having a spring-clamp tensioning a plurality of pinch-rollers positioned in a plane perpendicular to that of the plurality of rollers adapted to rest on top of the reactor steam dam, a drive mechanism for forward and reverse movement of the apparatus, wherein the drive mechanism powers a plurality of driver rollers positioned opposite to the pinch-rollers;
at least one turret-type assembly located on the carriage assembly for mounting and pivoting at least one extendable telescoping mast assembly, the at least one mast assembly being capable of extending a predetermined distance above and below the carriage assembly, the at least one mast assembly supporting at least one piece of inspection and maintenance equipment; and
a control mechanism for controlling the movement, inspection and maintenance attributes of the apparatus, the control mechanism being capable of being operated from a location remote from the apparatus.

2. The apparatus of claim 1, wherein the apparatus is adapted to navigate on a steam dam of a reactor core shroud.

3. The apparatus of claim 1, wherein the propulsion system further comprises a plurality of guide rails attached to the underside of the carriage assembly.

4. The apparatus of claim 5, wherein the guide rails are adapted to position and stabilize the apparatus on the reactor core shroud.

5. The apparatus of claim 1, wherein the pinch-roller assembly includes a pneumatic air cylinder, the pneumatic air cylinder capable of changing the traction force between the apparatus and the steam dam.

6. The apparatus of claim 1, wherein the carriage assembly is made watertight by sealing and by applying positive pressure.

7. The apparatus of claim 1, wherein the main body has at least one camera, wherein the at least one camera assists in positioning and locomotion of the apparatus by providing video feedback to the control mechanism.

8. The apparatus of claim 1, wherein the at least one mast assembly is capable of four degrees of freedom.

9. The apparatus of claim 8, wherein the at least one mast assembly includes a composite ribbon lift, wherein the composite ribbon lift includes a combination of extensions and worm gear components.

10. The apparatus of claim 9, wherein the composite ribbon lift comprises three steel spring individually coiled assemblies, wherein the three assemblies are capable of interlocking and creating a triangular mast.

11. The apparatus of claim 1, wherein the at least one mast assembly includes equipment for inspecting areas below and above the carriage assembly of the apparatus.

12. The apparatus of claim 11, wherein the equipment is at least one video camera.

13. The apparatus of claim 12, wherein the at least one video camera is shielded from radiation with tungsten housing.

14. The apparatus of claim 11, wherein the at least one video camera is capable of achieving EVT-1 standard.

15. The apparatus of claim 11, wherein the at least one video camera has a plurality of focus and zoom settings, wherein the plurality of focus and zoom settings are adjusted remotely.

16. The apparatus of claim 11, wherein the at least one video camera is a right-angle camera that utilizes a rotational elliptical mirror for viewing.

17. The apparatus of claim 16, wherein the right-angle camera rotates together with the elliptical mirror, and wherein the right-angle camera utilizes image compensation to correct for the effect of the elliptical mirror on the image.

18. The apparatus of claim 1, wherein the inspection equipment includes fiber-optic equipment such as a fiberscope.

19. The apparatus of claim 18, wherein the fiberscope is encased in a polyurethane sheath, wherein the fiberscope is composed of radiation-tolerant quartz fiber, and wherein the fiberscope is equipped with at least one lens.

20. The apparatus of claim 19, wherein the at least one lens is one of a fixed focal length lens and a variable focal length lens.

21. The apparatus of claim 1, wherein the at least one mast supports at least one of an ultrasonic testing probe, a torque wrench, a jet pump internal plating removal tool, a vacuum head, a grinder, a welding equipment, and a water jet.

22. The apparatus of claim 1, wherein the at least one mast assembly supports a float can, the float can containing a video camera connected to a fiber-optic device, the fiber-optic device extending downwardly and away from the float can along a guide tube assembly.

23. The apparatus of claim 22, wherein the float can is positively buoyant in deminiralized water.

24. The apparatus of claim 1, wherein the apparatus is connected to the control console using at least one cable, wherein the at least one cable is neutrally buoyant in deminiralized water.

25. The apparatus of claim 1, wherein the control mechanism comprises at least one console.

26. The apparatus of claim 1, wherein the apparatus is adapted to inspect at least one of jet pump hold down beams, internal and external jet pump nozzle and diffuser areas, wedge and restrainer, core shroud, core side items, core spray spargers, shroud welds, reactor vessel identification items located above the annulus area, feedwater spargers and header piping.

27. An apparatus for inspecting and maintaining in-vessel and annulus areas of boiling water reactors in nuclear power plants, the apparatus comprising;
a means for engaging the apparatus onto a boiling water reactor steam dam;
a propulsion means for propelling the apparatus along the steam dam;
at least one of an inspection and maintenance means mounted onto the apparatus; and
a control means for controlling the means for engaging, the propulsion means, and the at least one of the inspection and maintenance means.

28. An apparatus for inspecting and maintaining boiling water reactors in nuclear power plants, wherein the apparatus locates and navigates on a steam dam of a reactor core shroud, the apparatus comprising;
a watertight carriage assembly, the carriage assembly containing electrical control wiring and at least one video camera;
a propulsion system for propelling the apparatus, the propulsion system being mounted on the underside of the carriage assembly, wherein the propulsion system comprises a plurality of rollers adapted to rest on top of the reactor steam dam, a pinch-roller assembly having a spring-clamp and a pneumatic air cylinder tensioning a plurality of pinch-rollers positioned in a plane perpendicular to that of the plurality of rollers adapted to rest on top of the reactor steam dam, a drive mechanism for forward and reverse movement of the apparatus, wherein the drive mechanism powers a plurality of driver rollers positioned opposite the pinch-rollers with the aid of circumferential drive electrical motors;
at least one guide rail attached to the underside of the carriage assembly for positioning and stabilizing the apparatus on the reactor steam dam;
at least one turret-type assembly for mounting and pivoting at least one telescoping mast assembly, the at least one telescoping mast assembly being capable of extending at a selected distance above and below the carriage assembly, wherein the at least one mast assembly includes at least one piece of inspection equipment, the inspection equipment comprising at least one of a fiberscope composed of radiation-tolerant quartz, a tungsten-shielded video camera, the cameras having controllable focus and zoom adjustment settings, and a rotational right-angle camera with image rotation compensation; and
a control mechanism for remotely controlling the propulsion system, the at least one turret-type assembly, the at least one telescoping mast assembly, and the at least one piece of inspection equipment, the control mechanism comprising at least one console.

29. A mechanism for propelling and positioning equipment on a boiling water reactor steam dam, the mechanism comprising;
a drive mechanism for forward and reverse movement of the equipment along the steam dam, the drive mechanism including at least one motor for providing power to propel the apparatus;
a drive wheel assembly having a plurality of driver rollers attached to the at least one motor, wherein the driver rollers grip the side of the steam dam;
a pinch-roller assembly having a high-tension spring with a pneumatic air assist for movably securing a plurality of pinch rollers, wherein the pinch-rollers grip the side of the steam dam opposite the side of the driver rollers; and
a plurality of wheels adapted to rest on top of the steam dam.
